(19) United States
(12) Patent Application Publication
(10) Pub. No.: US 2016/0127461 A1
(43) Pub. Date: May 5, 2016

(54) METHOD AND APPARATUS FOR REAL TIME INTERACTIVE MODERATION OF NETWORK TRAFFIC

(71) Applicant: Barracuda Networks, Inc., Campbell, CA (US)

(72) Inventors: Zachary LEVOW, Camas, WA (US); Fleming SHI, Cupertino, CA (US)

(21) Appl. No.: 14/821,583

(22) Filed: Aug. 7, 2015

Related U.S. Application Data
(60) Provisional application No. 62/072,787, filed on Oct. 30, 2014.

(51) Int. Cl. H04L 29/08

(52) U.S. Cl. CPC H04L 67/1014; H04L 67/34; H04L 67/26

(57) ABSTRACT

A new approach is proposed that contemplates systems and methods to support interactive moderation of network traffic, where authorization to access certain web media content is approved or denied on a per-content item basis in real time. When a content requester initiates a request for a piece of web media content from a content provider over the Internet, the request is intercepted and either allowed, denied, or marked as requiring further approval based on content access policies and restrictions specific to the content requester. If the content request is marked as requiring further approval, it will be forwarded to a traffic moderator, which will make a decision on the request based on policies related to the content requester and the requested web media content in real time. The requester is then either allowed or denied access to the web media content based on the decision by the traffic moderator.

### CROSS-REFERENCE TO RELATED APPLICATIONS

This application claims the benefit of U.S. Provisional Patent Application No. 62/072,787, filed Oct. 30, 2014, and entitled “Method and Apparatus for Real Time Interactive Moderation of Network Traffic,” which is incorporated herein in its entirety by reference.

### BACKGROUND

People are increasingly accessing web media contents over the Internet in real time via various electronic devices. Here, the types of the web media contents include but are not limited to, web pages, multimedia contents (e.g., audio, image and/or video contents), programs and documents accessible over the Internet. The electronic devices used for accessing the web media contents over the Internet range from mobile phones, tablets to various forms of personal computers (e.g., desktops and laptops), even smart TVs and set-top-boxes. These electronic devices can often be in the hands of minors or individuals who have limited privileges to access the web media contents governed by either parental control or organizational policies/restrictions.

Sometimes, however, exceptions to the content restrictions need to be made to enable the minors and/or the restricted individuals to access certain pieces of web media contents. Today, these exceptions will require either pre-defined whitelist, bypass codes/secrets or manual intervention by the system administrator on the electronic device or a network that is being used to accessing the certain pieces of web media contents. Such pre-defined exceptions, however, often lack flexibility for real time interactive moderation. For a non-limiting example, a parent or an organization may not allow a minor or its employees to access certain website (e.g., YouTube) without discretion but would authorize access to certain contents on the website (a child-friendly movie or a work-related video) on a per-content item basis. As people are increasingly connected via various communication mediums including but not limited to email, social media and text messaging, a more convenient and efficient way to provide content moderation and authorization is desired.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a system diagram to support real time interactive moderation of network traffic in accordance with some embodiments.

FIG. 2 depicts a flowchart of an example of a process to support real time interactive moderation of network traffic in accordance with some embodiments.

### DETAILED DESCRIPTION OF EMBODIMENTS

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

A new approach is proposed that contemplates systems and methods to support real time interactive moderation of network traffic, where authorization to access certain web media content is approved or denied on a per-content item basis in real time. When a content requester (e.g., a minor or a company employee) initiates a request for a piece of web media content from a content provider over the Internet, the request is intercepted and either allowed, denied, or marked as requiring further approval based on content access policies and restrictions specific to the content requester. If the content request is marked as requiring further approval, it will be forwarded to a traffic moderator, which will make a decision on the request based on policies related to the content requester and the requested web media content in real time. For a non-limiting example, the policy could be on the profile of the content requester and the nature of the piece of the web media content requested. The content requester is then either allowed or denied access to the piece of web media content based on the moderation decision by the traffic moderator.

Under the proposed approach, the approval process to grant the content requester access to a certain piece of web media content is accomplished interactively in real-time without requiring a predefined lists of allowed or blocked web sites/contents for the content requester. In addition, authorization of access to the piece of web media content does not require the traffic moderator to be at the same physical/geographical location or in the same communication data path as the content requester. By intercepting the request for the piece of web media content and moderating the authorization process via various communication channels, the proposed approach reduces delays and enables real time web content request moderation for the content requester.

As referred to hereinafter, a content requester (CR) is a person who initiates the request to access a piece of web media content over the Internet via an associated electronic device. In some embodiments, the person is a minor whose access to the requested piece of web media content is subject to parental control or a company employee whose access to the requested piece of web media content is subject organizational policies or approval. As referred to hereinafter, a content provider (CR) is one or more server(s) hosting the piece of web media content requested by the content requester.

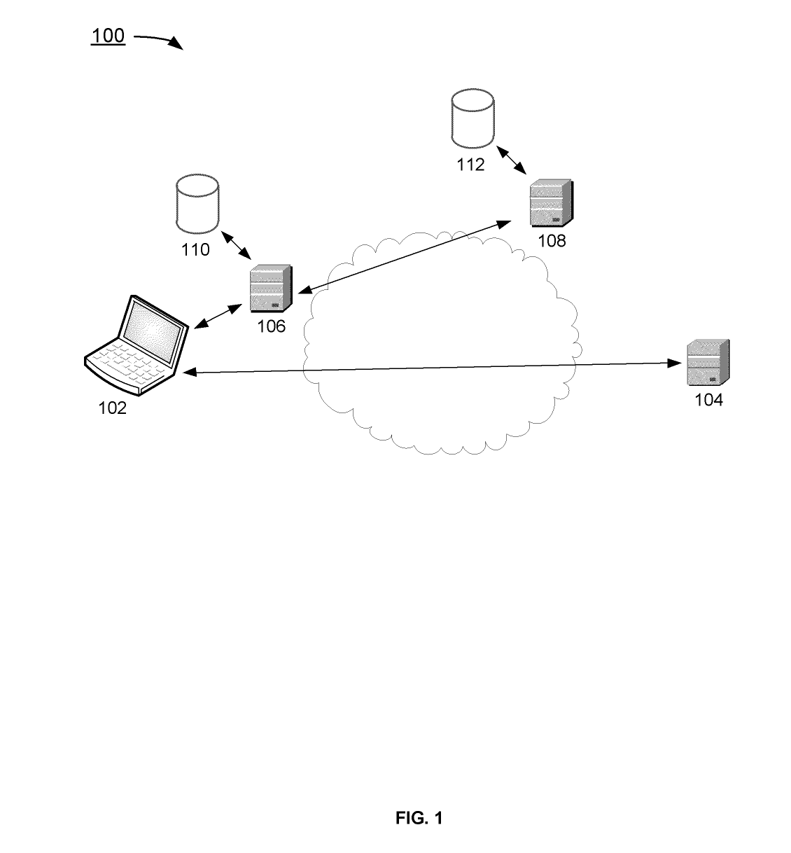

FIG. 1 depicts an example of a system diagram 100 to support real time interactive moderation of network traffic. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes a traffic interceptor 106 configured to intercept a request from a content requester via an electronic device 102 to access a piece of web media content hosted by content provider 104. The system 100 further includes a traffic moderator 108 configured to moderate (approve or deny) the request by the content requester to access the piece of web media content in real time. As used herein, the electronic device 102 can be but is not limited to a mobile communication device such as a mobile phone or a tablet, a personal computer such as a desktop or a laptop, a smart TV, a set-top-box, and any electronic device capable of transmitting the content request over the Internet. The content provider 104 typically includes one or more servers/hosts of the web media content and is accessible over the Internet. Each of the traffic interceptor 106 and the traffic moderator 108 includes a computing unit and software instructions that are stored in a storage unit such as a non-volatile memory (also referred to as secondary memory) of the computing unit for practicing one or more processes. When the software instructions are executed, at least a subset of the software instructions is loaded into memory (also referred to as primary memory) by the computing unit, the computing unit becomes a special purpose for practicing the processes. The processes may also be at least partially embodied in the computing unit into which computer program code is loaded and/or executed, such that, the computing unit becomes a special purpose computing unit for practicing the processes. When implemented on a general-purpose computing unit, the computer program code segments configure the computing unit to create specific logic circuits. Here, the computing unit can be a computing device, a communication device, or any electronic device capable of running a software component. For non-limiting examples, a computing device can be but is not limited to a laptop PC, a desktop PC, an iPod, an iPhone, an iPad, a Google's Android device, or a server machine.

In the example of FIG. 1, each of the electronic device 102 associated with the content requester, the content provider 104, the traffic interceptor 106, and the traffic moderator 108 are configured to communicate with each other following certain communication protocols, such as TCP/IP protocol, over one or more communication networks. Here, the communication networks can be but are not limited to, Internet, intranet, wide area network (WAN), local area network (LAN), wireless network, Bluetooth, WiFi, and mobile communication network. The physical connections of the network and the communication protocols are well known to those of skill in the art. The forms of information being communicated among the various parties listed above over the communication networks includes but is not limited to, emails, messages, web pages with optionally embedded objects (e.g., links to approve or deny the request).

In the example of FIG. 1, the traffic interceptor 106 is configured to intercept the request for the piece of web media content initiated by the content requester via the electronic device 102 before the request reaches the content provider 104. The traffic interceptor 106 is further configured to transmit the intercepted request to the traffic moderator 108 for moderation while prompting the content requester with a notification (e.g., in the form of a webpage that can be displayed on the electronic device 102) indicating that approval to access the piece of web media content requested is needed. Here, the request for the piece of web media content by the content requester typically includes information of the content provider such as hostname of the content provider and the part of the URL pointing to the piece of web media content hosted by the content provider. Such information can be used for decision making during the content moderation process as discussed below. In some embodiments, the traffic interceptor 106 can be implemented in the form of a proxy service module or a Domain Name System (DNS) responder.

In some embodiments, the traffic interceptor 106 is optionally configured to make a decision (approve or deny) on the requested piece of web media content by itself without forwarding the request to the traffic moderator 108. Under such scenario, a policy database 110 is optionally included, wherein the policy database 110 includes policies and constraints/restrictions on which pieces of web media contents are accessible by which of the content requesters, wherein the policies and constraints are either specific to each of the content requesters or applicable to all content requesters in general. These policies and constraints are either pre-specified by the traffic moderator 108 or dynamically collected and updated by the traffic interceptor 106 based on content accessing history of the content requester, e.g., which certain pieces of web media content or categories of such content were previously approved or denied for access by the traffic moderator 108. In some embodiments, the policies and constraints are applicable at the website level (e.g., all contents on YouTube are accessible or not by certain content requester), at the category level (e.g., URL's including certain keywords or phrases are allowed or denied for access), or at per-content level, where only a piece of web media content matching a pattern on a whitelist or blacklist are allowed or denied access by the content requester, wherein the pattern can be but is not limited to a name, a URL, or any form of key that can be used for the matching process.

In some embodiments, upon intercepting the request for the piece of web media content from the content provider, the traffic interceptor 106 is optionally configured to exact relevant information from the request and compare the information to the policies and/or constraints maintained in the policy database 110. If a match is found, the traffic interceptor 106 is configured to allow or block/deny the request and notify the content requester accordingly (e.g., via an approved or blocked webpage on the electronic device 102) without forwarding the request to the traffic moderator 108. If not match in found, the traffic interceptor 106 is configured to proceed to transmit the request to the traffic moderator 108 for moderation as discussed above.

In the example of FIG. 1, the traffic moderator 108 is configured to accept the content request for moderation and to make the decision on (approve or deny) the request for the specific piece of web media content. Here, the traffic moderator 108 is configured to approve or deny the request based on a plurality of factors that include but are not limited to profile of the content requester and information in the request related to the piece of web media content the content requester would like to access. For non-limiting examples, the profile of the content requester who is a minor may include name, age, gender, preferences, and past web media content access history of the content requester. The profile of the content requester who is a company employee may include ID, title, job responsibility, authorized web media content access level, and specific business needs of the content requester. In some embodiments, the traffic moderator 108 is configured to maintain and retrieve the profile of the content requester from profile database 112. Since the request includes information of the specific piece of web media content being requested by the content requester, the traffic moderator 108 is configured to perform content moderation on a per-web media content basis specific to the content requester. For a non-limiting example, the traffic moderator 108 is configured to approve access to one piece of web media content by one content requester while denying a request to access the same piece of web media content by another content requester. For another non-limiting example, the traffic moderator 108 is configured to approve access to one piece of web media content on a website while denying access to another piece of web media content on the same website by the same content requester.

In some embodiments, the traffic moderator 108 is configured to approve the request for the specific piece of web media content only for a specified period of time. For non-limiting examples, a minor is only allowed to access the piece of web media content during certain time of the day (e.g., before bedtime), and an employee is only allowed to access a work-related piece of web media content during the time period he/she works on a related task.

Once a decision on the request is made by the traffic moderator 108, a notification is provided to the content requester, for a non-limiting example, in the form a webpage on the electronic device 102 associated with the content requester. The awaiting content requester may then act accordingly, e.g., access the piece of web media content if the request is approved. In some embodiments, if the traffic moderator 108 denies the request to access the piece of web media content requested, the traffic moderator 108 is configured to provide reasoning and interactively collaborate with the content requester on the condition and/or manner the piece of web media content requested can be accessed. Here, the interactive communication between the traffic moderator 108 and the content requester can be done in the form of electronic message exchanges and links embedded in the webpages. In some embodiments, the traffic moderator 108 is configured to enable a person (e.g., system administrator or content moderator) to get involved to make a final decision, override a decision by the traffic moderator 108, or to comment and provide feedbacks during the interactive collaboration process and/or to update the profile of the content requester in the profile database 112 for future decision making by the traffic moderator 108.

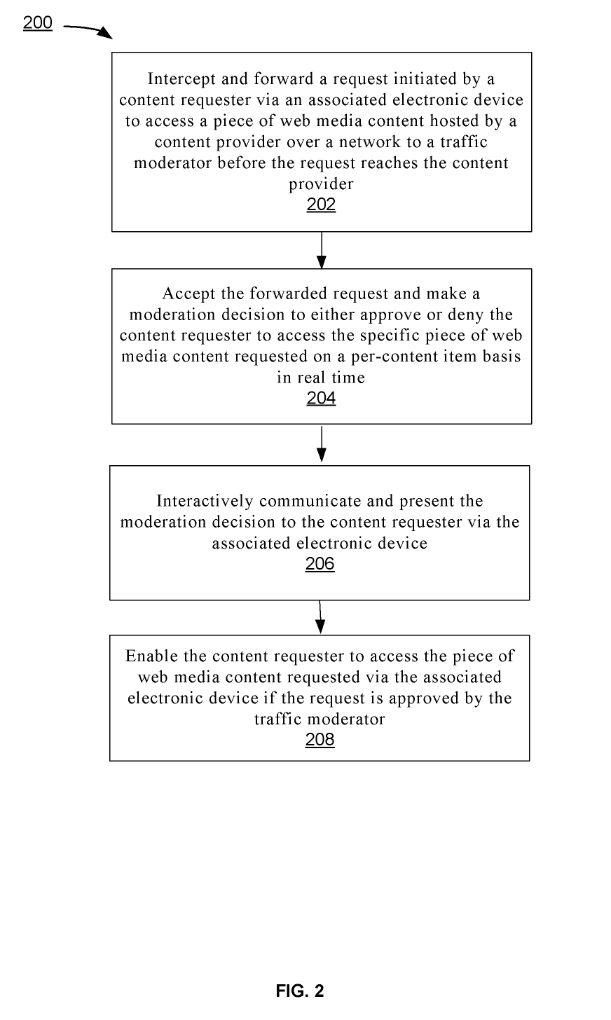

FIG. 2 depicts a flowchart of an example of a process to support real time interactive moderation of network traffic. Although the figure depicts functional steps in a particular order for purposes of illustration, the processes are not limited to any particular order or arrangement of steps. One skilled in the relevant art will appreciate that the various steps portrayed in this figure could be omitted, rearranged, combined and/or adapted in various ways.

In the example of FIG. 2, the flowchart 200 starts at block 202, a request initiated by a content requester via an associated electronic device to access a piece of web media content hosted by a content provider over a network is intercepted and forwarded to a traffic moderator before the request reaches the content provider. The flowchart 200 continues to block 204, where the forwarded request is accepted and a moderation decision is made to either approve or deny the content requester to access the specific piece of web media content requested on a per-content item basis in real time. The flowchart 200 continues to block 206 where the moderation decision is interactively communicated to and presented to the content requester via the associated electronic device. The flowchart 200 end at block 208 where the content requester is enabled to access the piece of web media content requested via the associated electronic device if the request is approved by the traffic moderator.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system to support real time interactive moderation of network traffic, comprising:
a traffic interceptor, which in operation, is configured to intercept and forward a request initiated by a content requester via an associated electronic device to access a piece of web media content hosted by a content provider over a network to a traffic moderator before the request reaches the content provider;
a traffic moderator, which in operation, is configured to:
accept the forwarded request and make a moderation decision to either approve or deny the content requester to access the specific piece of web media content requested on a per-content item basis in real time;
interactively communicate and present the moderation decision to the content requester via the associated electronic device;
enable the content requester to access the piece of web media content requested via the associated electronic device if the request is approved by the traffic moderator.

2. The system of claim 1, wherein:
the piece of web media content is one or more of a web pages, a multimedia content, a program and a document accessible over Internet.

3. The system of claim 1, wherein:
the electronic device is one of a mobile phone, a tablet, a desktop, a laptop, a smart TV and a set-top-box.

4. The system of claim 1, wherein:
the content requester is a minor or a company employee with limited privileges to access web media contents governed by either parental control or organizational policies/restrictions.

5. The system of claim 1, wherein:
the content provider is one or more servers hosting the piece of web media content requested by the content requester.

6. The system of claim 1, wherein:
the traffic interceptor and the traffic moderator runs on a computing device or any electronic device capable of running software component.

7. The system of claim 1, wherein:
the traffic interceptor is in the form of a proxy service module or a Domain Name System (DNS) responder.

8. The system of claim 1, wherein:
the traffic moderator locates a different geographical location and/or a communication data path from the content requester.

9. The system of claim 1, wherein:
the request for the piece of web media content includes hostname of the content provider and part of the URL pointing to the piece of web media content hosted by the content provider.

10. The system of claim 1, wherein:
the traffic interceptor is configured to provide the content requester with a notification indicating that approval to access the piece of web media content requested is needed while forwarding the request to the traffic moderator.

11. The system of claim 1, wherein:
the traffic interceptor is configured to approve or deny the intercepted request for the piece of web media content by itself without forwarding the request to the traffic moderator by exacting and matching relevant information from the request with policies and/or constraints on which pieces of web media contents are accessible by which content requesters.

12. The system of claim 11, wherein:
the policies and/or constraints are either pre-specified by the content moderator or dynamically collected and updated by the traffic interceptor based on content accessing history of the content requester.

13. The system of claim 11, wherein:
the policies and/or constraints are applicable at website level, category level, or at per-content level, where only the piece of web media content matching a pattern on a whitelist or a blacklist is allowed or denied access by the content requester.

14. The system of claim 11, wherein:
the traffic interceptor is configured to forward the request to the traffic moderator for moderation if no match is found.

15. The system of claim 1, wherein:
the traffic moderator is configured to approve or deny the request based on a plurality of factors that include profile of the content requester and information in the request related to the piece of web media content the content requester would like to access.

16. The system of claim 15, wherein:
the profile of the content requester who is a minor includes name, age, gender, preferences, and past web media content access history of the content requester.

17. The system of claim 15, wherein:
the profile of the content requester who is a company employee may include ID, title, job responsibility, authorized web media content access level, and specific business needs of the content requester.

18. The system of claim 1, wherein:
the traffic moderator is configured to approve access to one piece of web media content by one content requester while denying a request to access the same piece of web media content by another content requester.

19. The system of claim 1, wherein:
the traffic moderator is configured to approve access to one piece of web media content on a website while denying access to another piece of web media content on the same website by the same content requester.

20. The system of claim 1, wherein:
the traffic moderator is configured to approve the request for the piece of web media content only for a specified period of time.

21. The system of claim 1, wherein:
the traffic moderator is configured to provide reasoning and interactively collaborate with the content requester on the condition and/or manner the piece of web media content requested can be accessed if the traffic moderator denies the request to access the piece of web media content.

22. The system of claim 21, wherein:
the traffic moderator is configured to enable a person to get involved in the interactive collaboration process to make a final decision, to override the decision by the traffic moderator, to comment and provide feedbacks and/or to update the profile of the content requester for future decision making by the traffic moderator.

23. A computer-implemented method to support real time interactive moderation of network traffic, comprising:
intercepting and forwarding a request initiated by a content requester via an associated electronic device to access a piece of web media content hosted by a content provider over a network to a traffic moderator before the request reaches the content provider;
accepting the forwarded request and making a moderation decision to either approve or deny the content requester to access the specific piece of web media content requested on a per-content item basis in real time;
interactively communicating and presenting the moderation decision to the content requester via the associated electronic device;
enabling the content requester to access the piece of web media content requested via the associated electronic device if the request is approved by the traffic moderator.

24. The computer-implemented method of claim 23, further comprising:
the traffic moderator locates a different geographical location and/or a communication data path from the content requester.

25. The computer-implemented method of claim 23, further comprising:
providing the content requester with a notification indicating that approval to access the piece of web media content requested is needed while forwarding the request to the traffic moderator.

26. The computer-implemented method of claim 23, further comprising:
approving or denying on the intercepted request for the piece of web media content by itself without forwarding the request to the traffic moderator by extracting and matching relevant information from the request with policies and/or constraints on which pieces of web media contents are accessible by which content requesters.

27. The computer-implemented method of claim 26, further comprising:
forwarding the request to the traffic moderator for moderation if no match is found.

28. The computer-implemented method of claim 23, further comprising:
approving or denying the request by the traffic moderator based on a plurality of factors that include profile of the content requester and information in the request related to the piece of web media content the content requester would like to access.

29. The computer-implemented method of claim 28, further comprising:
approving access to one piece of web media content by one content requester while denying a request to access the same piece of web media content by another content requester.

30. The computer-implemented method of claim 28, further comprising:
approving access to one piece of web media content on a website while denying access to another piece of web media content on the same website by the same content requester.

31. The computer-implemented method of claim 23, further comprising:
approving the request for the piece of web media content only for a specified period of time.

32. The computer-implemented method of claim 23, further comprising:
providing reasoning and interactively collaborating with the content requester on the condition and/or manner the piece of web media content requested can be accessed if the traffic moderator denies the request to access the piece of web media content.

33. The computer-implemented method of claim 32, further comprising:
enabling a person to get involved in the interactive collaboration process to make a final decision, to comment and provide feedbacks, comments and/or to update the profile of the content requester for future decision making by the traffic moderator.
